(19) United States
(12) Patent Application Publication
(10) Pub. No.: US 2025/0028174 A1
(43) Pub. Date: Jan. 23, 2025

(54) OPTICAL SYSTEM AND HEAD-MOUNTED DEVICE

(71) Applicant: Goertek Optical Technology Co., Ltd., Weifang, Shandong (CN)

(72) Inventor: Chaiyuan SHI, Shandong (CN)

(73) Assignee: Goertek Optical Technology Co., Ltd., Weifang, Shandong (CN)

(21) Appl. No.: 18/714,692

(22) PCT Filed: Dec. 14, 2021
(86) PCT No.: PCT/CN2021/137639

§ 371 Date: May 30, 2024

(30) Foreign Application Priority Data
Nov. 30, 2021 (CN) 202111439167.4

(51) Int. Cl. G02B 27/01; G02B 9/14

(52) U.S. Cl. CPC G02B 27/0172; G02B 9/14; G02B 2027/0116; G02B 2027/013

(57) ABSTRACT

Disclosed are an optical system and a head-mounted device. The optical system comprises a beam-splitter, a first lens, a second lens, and a third lens in sequence along a light transmission direction, wherein, the first lens has a positive focal power; the second lens has a negative focal power; the third lens has a positive focal power, and is provided with a polarization-reflecting film on a light incident surface thereof; defining a refractive index of the first lens as n₁, a refractive index of the second lens as n₂, a refractive index of the third lens as n₃, a chromatic dispersion coefficient of the first lens as v₁, a chromatic dispersion coefficient of the second lens as v₂, and a chromatic dispersion coefficient of the third lens as v₃, then n₁<n₂, n₂>n₃, v₁>v₂, and v₂<v₃.

### CROSS-REFERENCE TO RELATED APPLICATIONS

This application is a National Stage of International Application No. PCT/CN2021/137639, filed on Dec. 14, 2021, which claims priority to Chinese Patent Application No. 202111439167.4, filed on Nov. 30, 2021, both of which are hereby incorporated by reference in their entireties.

### TECHNICAL FIELD

The present disclosure relates to the field of virtual reality, and particularly to an optical system and a head-mounted device.

### BACKGROUND

With the development of science and technology, the head-mounted device is gradually evolving towards smaller size, lighter weight, and higher portability.

To satisfy the requirement of smaller size, the display screen inside the head-mounted device is becoming smaller and smaller while offering a larger and larger field of view. This requires the head-mounted device to ensure high-resolution imaging and low chromatic aberration while satisfying the requirements of a large field of view and small image height.

### SUMMARY

Based on the above, to address the issue of the head-mounted device having the low imaging resolution and the large chromatic aberration while satisfying the large field of view and the small image height, there is a need to provide an optical system and a head-mounted device so as to improve the imaging resolution and reduce the chromatic aberration.

To achieve the above purpose, the present disclosure proposes an optical system, comprising a beam-splitter, a first lens, a second lens, and a third lens in sequence along a light transmission direction, wherein,
the first lens has a positive focal power,
the second lens has a negative focal power,
the third lens has a positive focal power, and is provided with a polarization-reflecting film on a light incident surface thereof,
defining a refractive index of the first lens as n₁, a refractive index of the second lens as n₂, a refractive index of the third lens as n₃, a chromatic dispersion coefficient of the first lens as v₁, a chromatic dispersion coefficient of the second lens as v₂, and a chromatic dispersion coefficient of the third lens as v₃, then n₁<n₂, n₂>n₃, v₁>v₂, and v₂<v₃.

Optionally, the refractive indices of the first lens, the second lens, and the third lens are all greater than 1.45 and less than 1.8; the chromatic dispersion coefficients of the first lens, the second lens, and the third lens are all greater than 25 and less than 75.

Optionally, a light incident surface of the first lens is a convex surface with a radius of curvature being greater than 20 mm and less than 100 mm; and a light incident surface of the third lens is a convex surface with a radius of curvature being greater than 20 mm and less than 100 mm

Optionally, a difference between the radii of curvature of the light incident surface of the first lens and the light incident surface of the third lens is not greater than 10 mm.

Optionally, a light incident surface and a light emergent surface of the first lens are aspherical structures: and a light incident surface and a light emergent surface of the third lens are aspherical structures.

Optionally, any of a light emergent surface of the first lens, a light incident surface of the second lens, a light emergent surface of the second lens, and the light incident surface of the third lens is provided with a quarter-wave plate.

Optionally, the optical system satisfies the following relationship: 3 mm<T₁<8 mm, 3 mm<T₂<5 mm, 3 mm<T₃<8 mm, wherein T₁ is a central thickness of the first lens, T₂ is a central thickness of the second lens, and T₃ is a central thickness of the third lens.

Optionally, an effective focal length of the optical system is greater than 15 mm and less than 20 mm.

Optionally, the optical system further comprises a display unit and a protective glass, and the display unit is provided on a side of the beam-splitter distal to the first lens: the protective glass is provided between the display unit and the beam-splitter.

In addition, to achieve the above purpose, the present disclosure further provides a head-mounted device comprising a housing and the optical system as described in any of the above.

In the technical solution proposed by the present disclosure, the optical system comprises a beam-splitter, a first lens with a positive focal power, a second lens with a negative focal power, and a third lens with a positive focal power in sequence along a light transmission direction, and the third lens is provided with a polarization-reflecting film on a light incident surface thereof. The first lens has a lower refractive index and a higher chromatic dispersion coefficient, the second lens has a higher refractive index and a lower chromatic dispersion coefficient, and the third lens has a lower refractive index and a higher chromatic dispersion coefficient. The light passing through the folded optical path formed by the above lenses before entering the human eye may effectively reduce the chromatic aberration, improve resolution and the imaging clarity, and achieve the high-resolution imaging.

### BRIEF DESCRIPTION OF THE DRAWINGS

In order to clearly illustrate embodiments of the present application or technical solutions in the prior art, accompanying drawings that need to be used in description of the embodiments or the prior art will be briefly introduced as follows. Obviously, drawings in following description are only the embodiments of the present application. For those skilled in the art, other drawings can also be obtained according to the disclosed drawings without creative efforts.

FIG. 1 shows a structural schematic diagram of an optical system of the present disclosure:

FIG. 2 shows a schematic diagram of dispersion angle of a display unit of the optical system of the present disclosure:

FIG. 3 shows a schematic diagram of a relationship between an incidence angle of a chief light ray and an image height of the optical system of the present disclosure:

FIG. 4 shows a modulation transfer function diagram of a first embodiment of the optical system of the present disclosure:

FIG. 5 shows a spot diagram of a first embodiment of the optical system of the present disclosure:

FIG. 6 shows a chromatic aberration diagram of a first embodiment of the optical system of the present disclosure;

FIG. 7 shows a modulation transfer function diagram of a second embodiment of the optical system of the present disclosure:

FIG. 8 shows a spot diagram of a second embodiment of the optical system of the present disclosure;

FIG. 9 shows a chromatic aberration diagram of a second embodiment of the optical system of the present disclosure.

### DESCRIPTION OF REFERENCE SIGNS

| Sign | Name |
|---|---|
| 10 | Display Unit |
| 20 | Protective Glass |
| 30 | First Lens |
| 40 | Second Lens |
| 50 | Third Lens |
| 60 | Human Eye |

The realization of the objective, functional features and advantages of the present disclosure will be further explained with reference to the attached drawings in connection with the embodiments.

### DETAILED DESCRIPTION

The technical solutions in the embodiments of the present application will be clearly and completely described below in conjunction with the accompanying drawings in the embodiments of the present application. Obviously, the described embodiments are only a part of the embodiments of the present application, rather than all of them. Based on the embodiments in the present application, all other embodiments obtained by a person of ordinary skill in the art without making creative labor shall fall within the scope of protection of the present application.

It should be noted that all directional indications (such as up, down, left, right, front, back, etc.) in the embodiments of the present disclosure are solely for explaining the relative positional relationships and motion conditions between various components in a specific orientation (as shown in the accompanying drawings). If that specific orientation changes, the directional indications will correspondingly change as well.

In addition, terms such as “first” and “second” involved in the present disclosure are only used for descriptive purposes, and should not be understood as indicating or implying relative importance or implying a number of indicated technical features. Therefore, features defined as “first”, “second” may expressly or implicitly include at least one of those features. In the description of the present application, “plurality” means at least two, such as two, three, etc., unless expressly and specifically defined otherwise.

In the present disclosure, unless otherwise expressly specified and defined, terms such as “connected” and “fixed” should be interpreted in a broad sense, for example, “fixed” can be a fixed connection, a detachable connection, or an integrated: it can be a mechanical connection or an electrical connection: it can be a direct connection or an indirect connection through an intermediate medium: it may be connection within the two elements or an interaction relationship between the two elements, unless explicitly defined otherwise. For those of ordinary skill in the art, the specific meanings of the above terms in the present application can be understood according to specific situations.

Additionally, the technical solutions of the various embodiments in the present disclosure may be combined with each other, but they must be based on the premise that they may be implemented by ordinary skilled in the art. When the combination of technical solutions is contradictory or unfeasible, it should be considered that such a combination does not exist and is not within the protection scope claimed by the present disclosure.

The present disclosure provides an optical system and a head-mounted device.

Please refer to FIG. 1, the optical system comprise a beam-splitter (not shown in FIG. 1), a first lens 30, a second lens 40, and a third lens 50 in sequence along a light transmission direction, wherein,
the first lens 30 has a positive focal power,
the second lens 40 has a negative focal power, and
the third lens 50 has a positive focal power, and is provided with a polarization-reflecting film on a light incident surface thereof,
defining a refractive index of the first lens 30 as n₁, a refractive index of the second lens 40 as n₂, a refractive index of the third lens 50 as n₃, a chromatic dispersion coefficient of the first lens 30 as v₁, a chromatic dispersion coefficient of the second lens 40 as v₂, and a chromatic dispersion coefficient of the third lens 50 as v₃, then n₁<n₂, n₂>n₃, v₁>v₂, and v₂<v₃.

Specifically, the beam-splitter splits the incident light, allowing a part of the light to pass through and reflecting a part of the light, and it may specifically be a transflective film and may be provided on the side of the light incident surface of the first lens 30 by attaching or coating.

In the technical solution proposed by the present disclosure, light enters from the light incident surface of the first lens 30, transmits through the first lens 30 and the second lens 40, is polarized and reflected by the light incident surface of the third lens 50, transmits through the second lens 40, is reflected at the light incident surface of the first lens 30, transmits through the light emergent surface of the first lens 30, through the second lens 40, and through the third lens 50, and finally enters the human eye 60.

Through the folded optical path formed by the above lenses, light may be reflected several times to increase the optical path length, thereby reducing the volume of the optical system. Moreover, by combining the structures and materials of each lens, it is possible to effectively reduce chromatic aberration, improve resolution and imaging clarity, and achieve high-resolution imaging.

In an alternative embodiment, anti-reflective films may be provided on a light emergent surface of the first lens 30, a light incident surface and a light emergent surface of the second lens 40, and a light emergent surface of the third lens 50 so as to enhance the transmission of light through the corresponding optical surfaces.

In an alternative embodiment, the refractive indices of the first lens 30, the second lens 40, and the third lens 50 are all greater than 1.45 and less than 1.8. Specifically, the refractive index refers to a ratio of the speed of light propagating in a vacuum to the speed of light propagating in the medium. The higher the refractive index of a material, the stronger its ability to refract the incident light.

In an alternative embodiment, the chromatic dispersion coefficients of the first lens 30, the second lens 40, and the third lens 50 are all greater than 25 and less than 75. Specifically, the chromatic dispersion coefficient is an important indicator of the imaging quality of the lens, usually represented by Abbe number. The larger the chromatic dispersion coefficient, the less obvious the chromatic dispersion, which indicates a better imaging quality of the lens: the smaller the chromatic dispersion coefficient, the more obvious the chromatic dispersion, which indicates a worse imaging quality of the lens.

The optical system composed of lenses with refractive indices and chromatic dispersion coefficients within the above ranges may effectively reduce imaging chromatic aberration and improve imaging resolution.

In an alternative embodiment, both the light incident surface of the first lens 30 and that of the third lens 50 are convex surfaces. A radius of curvature of the light incident surface of the first lens 30 is greater than 20 mm and less than 100 mm, and a radius of curvature of the light incident surface of the third lens 50 is greater than 20 mm and less than 100 mm.

Furthermore, the difference between the radii of curvature of the light incident surface of the first lens 30 and the light incident surface of the third lens 50 is not greater than 10 mm, which is conducive to achieving achromatic aberration-free, high-resolution imaging of the optical system.

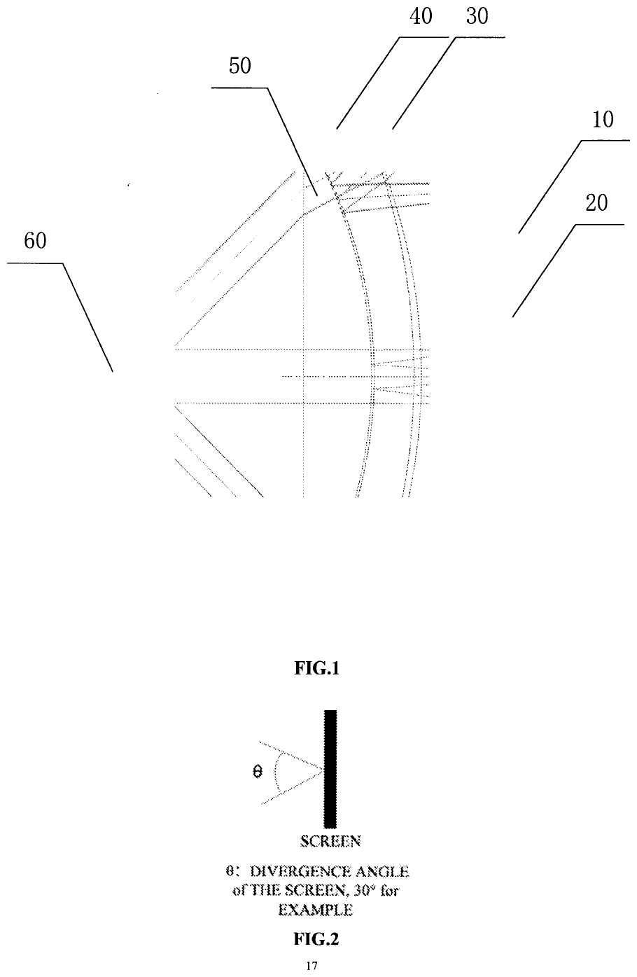

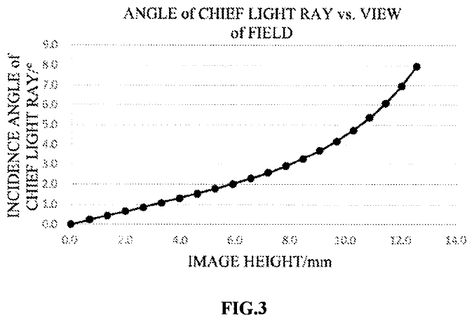

Please refer to FIGS. 2 and 3, FIG. 2 shows a schematic diagram of the dispersion angle of a display unit of the optical system, and FIG. 3 shows a schematic diagram of the relationship between the incidence angle of the chief light ray and the image height of the optical system.

When the optical system is applied to the head-mounted device, the head-mounted device further comprises a display unit, such as a display screen, for emitting light rays.

In FIG. 2, assuming the divergence angle of the display screen is 30°, the light incident surface of the first lens and the light incident surface of the third lens reflect the light ray convexly, and when they are nearly parallel, they may make the incidence angle of the chief light ray of the display screen to approximate 0, which is less than the divergence angle of the display screen, thereby improving the light efficiency utilization of the display unit. Therefore, by setting the difference between the radii of curvature of the light incident surface of the first lens and the light incident surface of the third lens to not greater than 10 mm, it is conducive to improving the light efficiency utilization and reducing the volume of the optical system.

In an alternative embodiment, the light incident surface and the light emergent surface of the first lens 30 are aspherical structures, and the light incident surface and the light emergent surface of the third lens 50 are aspherical structures. Wherein, an aspherical surface is a surface whose curvature gradually changes from the center to the edge of the lens. This gradual change in curvature may either increase or decrease gradually. This continuous curvature change may reduce the difference in imaging near the optical axis and away from the optical axis, that is, it may reduce the aberration of imaging at edges, thereby improving the performance of the optical system and facilitating the miniaturization of the optical system.

In an alternative embodiment, any of the light emergent surface of the first lens 30, the light incident surface of the second lens 40, the light emergent surface of the second lens 40, and the light incident surface of the third lens 50 is provided with a quarter-wave plate. The quarter-wave plate may produce a relative phase delay between two orthogonal polarization components of polarized light, thereby changing the polarization characteristics of light, that is, achieving a conversion between the linearly polarized light and the elliptically polarized light.

For example, if the light emergent surface of the second lens 40 is provided with the quarter-wave plate, the light changes as follows: light (such as circularly polarized light) enters from the light incident surface of the first lens 30, transmits through the first lens 30 and the second lens 40 to become the linearly polarized light, is polarized and reflected by the light incident surface of the third lens 50, transmits through the second lens 40 to become the circularly polarized light, is reflected at the light incident surface of the first lens 30, transmits through the light emergent surface of the first lens 30 and the second lens 40 to become the linearly polarized light, transmits through the third lens 50, and finally enters the human eye 60.

In an alternative embodiment, the optical system satisfies the following relationship: 3 mm<T₁<8 mm, 3 mm<T₂<5 mm, 3 mm<T₃<8 mm, wherein T₁ is the central thickness of the first lens, T₂ is the central thickness of the second lens, and T₃ is the central thickness of the third lens. By limiting the range of the center thickness of each lens, it is possible to make the optical system thinner and to reduce the size of the optical system.

In an alternative embodiment, the effective focal length of the optical system is greater than 15 mm and less than 20 mm.

In an alternative embodiment, the optical system further comprises a display unit 10 and a protective glass 20. The display unit 10 is provided on the side of the light incident surface of the first lens 30, emits light and directs it into the first lens 30, and may be an LCD, OLED, Micro-oled, etc. The protective glass 20 is provided on the side of the display unit 10 close to the first lens 30, and is used to protect the display unit 10 from impact by the external environment or other components.

### First Embodiment

In the first embodiment, the optical power of the first lens is 0.0066, the optical power of the second lens is −0.00607, and the optical power of the third lens is 0.0138. The difference in the radii of curvature between the light incident surface of the first lens and the light incident surface of the third lens is 10 mm, and the design data of the optical system is shown in the following Table 1:

TABLE 1

| optical | optical | radius/ | thickness/ | | | | |
|---|---|---|---|---|---|---|---|
| element | surfae | mm | mm | material | a4 | a6 | a8 |
| third | light | inf | 5.0 | K26R | −7.6E−06 | 1.1E−08 | −3.8E−12 |
| lens | emergent | | | | | | |
| | surface | | | | | | |
| | light | −40.0 | 0.45 | | 0.0E+00 | 0.0E+00 | 0.0E+00 |
| | incident | | | | | | |
| | surface | | | | | | |
| second | light | −34.7 | 3.0 | H-ZF6 | 0.0E+00 | 0.0E+00 | 0.0E+00 |
| lens | emergent | | | | | | |
| | surface | | | | | | |
| | light | −49.5 | 0.6 | | −1.3E−05 | 4.1E−08 | −3.8E−11 |
| | incident | | | | | | |
| | surface | | | | | | |
| first | light | −48.0 | 4.8 | APL5014CL | −1.7E−06 | 2.0E−09 | 2.2E−12 |
| lens | emergent | | | | | | |
| | surface | | | | | | |
| | light | −30.0 | 2.5 | | −1.3E−05 | 4.1E−08 | −3.8E−11 |
| | incident | | | | | | |
| | surface | | | | | | |

Wherein, the thickness represents the distance from this optical surface to the next optical surface, the material indicates that the medium between this optical surface and the next one is of the same material, and a4, a6, a8 represent the coefficients of the higher-order terms used for profile calculation.

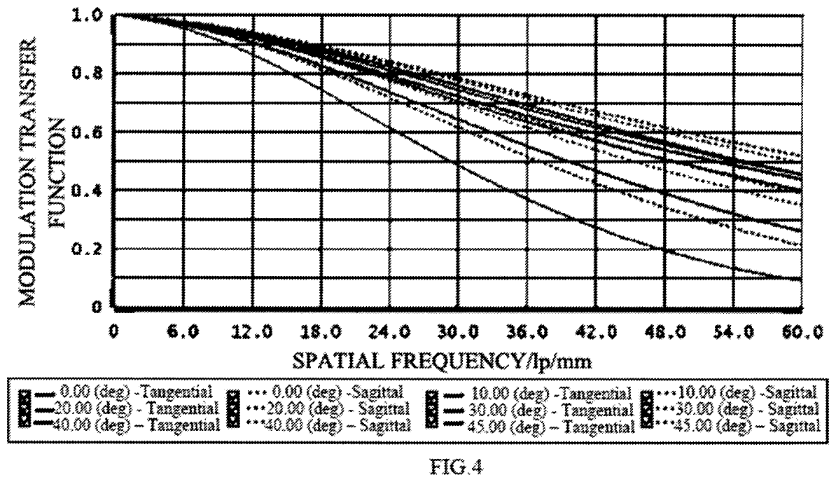

Please refer to FIG. 4, it is the modulation transfer function (MTF) diagram of the first embodiment. The modulation transfer function (MTF) refers to the relationship between the degree of modulation and the number of line pairs per millimeter within the image, and is used to evaluate the ability to reproduce fine details of a scene. The higher the value on the longitudinal axis of the MTF, the higher the imaging resolution. The MTF in the diagram is greater than 0.1 at 60 lp/mm, which indicates that the imaging resolution is clear.

Please refer to FIG. 5, it is the spot diagram of the first embodiment. The spot diagram refers to a diffuse pattern scattered in a certain range which is formed since many ray's emitted from a single point, after passing through the optical system, and the intersection of the image plane are no longer focused on the same point due to optical aberrations, which is used to evaluate the imaging quality of the optical system. The maximum value of the image point in the spot diagram corresponds to the maximum field of view, and the maximum size in the spot diagram is at the maximum field of view at the edge, which is less than 7.5 um, indicating high-definition imaging.

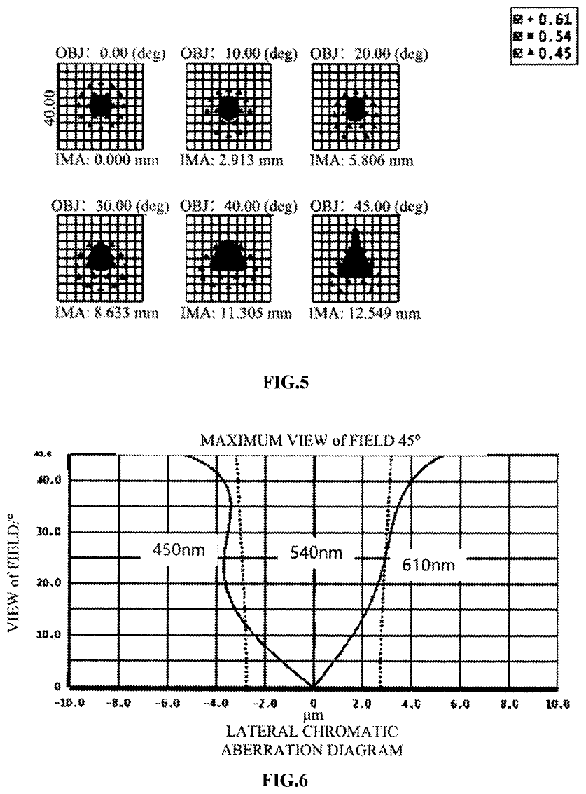

Please refer to FIG. 6, it is the chromatic dispersion diagram of the first embodiment, which means that a polychromatic chief light ray on the object side becomes multiple rays when it exits on the image side due to chromatic dispersion in the refraction system. The maximum chromatic aberration in the figure is at the maximum field of view, and the maximum value is less than 10 μm, which may be regarded as no chromatic aberration.

### Second Embodiment

In the second embodiment, the optical power of the first lens is 0.0066, the optical power of the second lens is −0.00645, and the optical power of the third lens is 0.016. The difference in the radii of curvature between the light incident surface of the first lens and the light incident surface of the third lens is 4.2 mm, and the design data of the optical system is shown in the following Table 2:

TABLE 2

| optical | optical | radius | thickness | | | | |
|---|---|---|---|---|---|---|---|
| element | surfae | (mm) | (mm) | material | a4 | a6 | a8 |
| third | Light | inf | 5.2 | K26R | 0.0E+00 | 0.0E+00 | 0.0E+00 |
| lens | emergent | | | | | | |
| | surface | | | | | | |
| | Light | −34.3 | 0.2 | | −1.0E−06 | 9.6E−09 | −8.7E−12 |
| | incident | | | | | | |
| | surface | | | | | | |
| second | Light | −33.6 | 3.0 | H-ZF6 | 0.0E+00 | 0.0E+00 | 0.0E+00 |
| lens | emergent | | | | | | |
| | surface | | | | | | |
| | Light | −48.8 | 0.6 | | 0.0E+00 | 0.0E+00 | 0.0E+00 |
| | incident | | | | | | |
| | surface | | | | | | |
| first | Light | −44.8 | 4.8 | APL5014CL | −0.5E−06 | 3.3E−08 | −3.4E−11 |
| lens | emergent | | | | | | |
| | surface | | | | | | |
| | Light | −30.1 | 2.5 | | −1.5E−06 | 1.5E−09 | 3.1E−12 |
| | incident | | | | | | |
| | surface | | | | | | |

Wherein, the thickness represents the distance from this optical surface to the next optical surface, the material indicates that the medium between this optical surface and the next one is of the same material, and a4, a6, a8 represent the coefficients of the higher-order terms used for profile calculation.

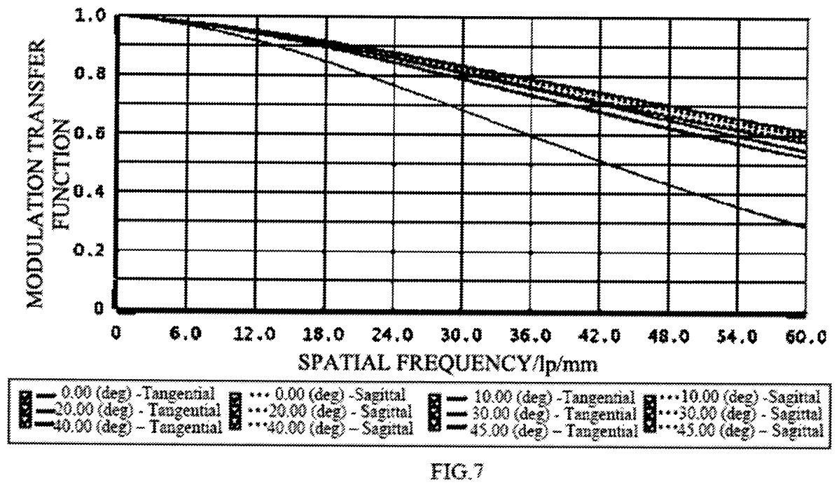

Please refer to FIG. 7, it is the modulation transfer function (MTF) diagram of the second embodiment. The modulation transfer function (MTF) refers to the relationship between the degree of modulation and the number of line pairs per millimeter within the image, and is used to evaluate the ability to reproduce fine details of a scene. The higher the value on the longitudinal axis of the MTF, the higher the imaging resolution. The MTF in the diagram is greater than 0.3 at 60 lp/mm, which indicates that high resolution imaging.

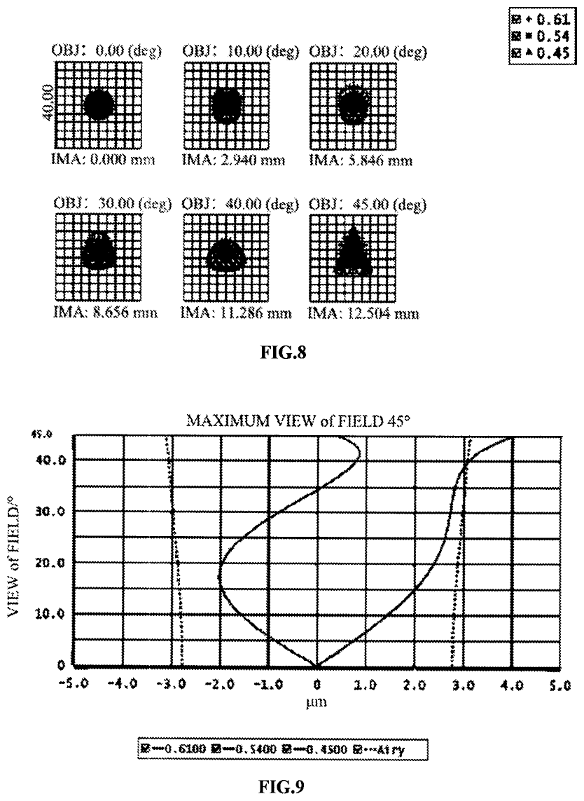

Please refer to FIG. 8, it is the spot diagram of the second embodiment. The spot diagram refers to a diffuse pattern scattered in a certain range which is formed since many rays emitted from a single point, after passing through the optical system, and the intersection of the image plane are no longer focused on the same point due to optical aberrations, which is used to evaluate the imaging quality of the optical system. The maximum value of the image point in the spot diagram corresponds to the maximum field of view, and the maximum size in the spot diagram is at the maximum field of view at the edge, which is less than 6 μm, indicating high-definition imaging.

Please refer to FIG. 9, it is the chromatic dispersion diagram of the second embodiment, which means that a polychromatic chief light ray on the object side becomes multiple rays when it exits on the image side due to chromatic dispersion in the refraction system. The chromatic aberration in the figure is within the Airy spot, the maximum chromatic aberration is near the field of view of 0.45, and the maximum value is less than 4 μm, which may be regarded as no chromatic aberration.

The present disclosure further proposes a head-mounted device comprising a housing and the optical system as described in any of the above embodiments. The specific structure of the optical system refers to the above embodiments, and since the optical system adopts all the technical solutions of the above embodiments, the head-mounted device has at least all the beneficial effects brought by the technical solutions of the above embodiments, which will not be repeated herein.

The foregoing are merely preferred embodiments of the present disclosure and are not to be construed as limiting the scope of the present disclosure. Any equivalent structural transformation made by using the specification and drawings of the present disclosure under the inventive concept of the present disclosure, or direct/indirect application in other related technical fields are included in the patent protection scope of the present disclosure.

1. An optical system, comprising a beam-splitter, a first lens, a second lens, and a third lens in sequence along a light transmission direction, wherein
the first lens has a positive focal power,
the second lens has a negative focal power, and
the third lens has a positive focal power, and is provided with a polarization-reflecting film on a light incident surface thereof; and
a refractive index of the first lens is defined as n₁, a refractive index of the second lens is defined as n₂, a refractive index of the third lens is defined as n₃, a chromatic dispersion coefficient of the first lens is defined as v₁, a chromatic dispersion coefficient of the second lens is defined as v₂, and a chromatic dispersion coefficient of the third lens is defined as v₃,
wherein n₁<n₂, n₂>n₃, v₁>v₂, and v₂<v₃.

2. The optical system according to claim 1, wherein
the refractive indices of the first lens, the second lens, and the third lens are all greater than 1.45 and less than 1.8; and
the chromatic dispersion coefficients of the first lens, the second lens, and the third lens are all greater than 25 and less than 75.

3. The optical system according to claim 1, wherein
a light incident surface of the first lens is a convex surface with a radius of curvature being greater than 20 mm and less than 100 mm; and
a light incident surface of the third lens is a convex surface with a radius of curvature being greater than 20 mm and less than 100 mm.

4. The optical system according to claim 3, wherein a difference between the radii of curvature of the light incident surface of the first lens and the light incident surface of the third lens is not greater than 10 mm.

5. The optical system according to claim 1, wherein
a light incident surface and a light emergent surface of the first lens are aspherical structures; and
a light incident surface and a light emergent surface of the third lens are aspherical structures.

6. The optical system according to claim 1, wherein any of a light emergent surface of the first lens, a light incident surface of the second lens, a light emergent surface of the second lens, and the light incident surface of the third lens is provided with a quarter-wave plate.

7. The optical system according to claim 1,
wherein T₁ is a central thickness of the first lens, T₂ is a central thickness of the second lens, and T₃ is a central thickness of the third lens; and
wherein the optical system satisfies the following relationship:
$$3 mm < {T}_{1} < 8 mm , 3 mm < {T}_{2} < 5 mm , 3 mm < {T}_{3} < 8 mm .$$

8. The optical system according to claim 1, wherein an effective focal length of the optical system is greater than 15 mm and less than 20 mm.

9. The optical system according to claim 1, wherein the optical system further comprises a display unit and a protective glass, wherein
the display unit is provided on a side of the beam-splitter distal to the first lens; and
the protective glass is provided between the display unit and the beam-splitter.

10. A head-mounted device, comprising a housing and the optical system according to claim 1.
